(19) United States
(12) Patent Application Publication
(10) Pub. No.: US 2019/0012834 A1
(43) Pub. Date: Jan. 10, 2019

(54) Augmented Content System and Method

(71) Applicant: Mouse Prints Press BV, Amsterdam (NL)

(72) Inventors: Jerry S. Friedman, Amsterdam (NL); Willem van Leunen, Amsterdam (NL)

(21) Appl. No.: 15/602,486

(22) Filed: May 23, 2017

Related U.S. Application Data
(60) Provisional application No. 62/340,206, filed on May 23, 2016.
(60) Provisional application No. 62/430,860, filed on Dec. 6, 2016.

(51) Int. Cl. G06T 19/00; G06K 9/62; A63F 13/5375

(52) U.S. Cl. CPC G06T 19/006; G06K 9/6202; A63F 2300/305; G06T 19/003; A63F 13/5375

(57) ABSTRACT

A system and method for applying augmented reality to allow a user of a game to locate clues that are remote from the user's location.

### CLAIM FOR PRIORITY

This application claims priority to and incorporates by reference U.S. Provisional Patent Application Nos. 62/340,206 filed on May 23, 2016 and 62/430,860 filed on Dec. 6, 2016.

### FIELD OF THE INVENTION

This invention is generally directed to a system and method for applying augmented reality to allow a user of a game to locate clues that are remote from the user's location.

### BACKGROUND OF THE INVENTION

Treasure and scavenger hunts been carried out as an entertainment activity, an education activity or infotainment activity for many years. In a typical activity, a participant is given a list of clues, and then physically locates those clues. In the computer age these types of activities have expanded to allow users to interact with a computer to update the gaming administrators to clues that they have found.

One type of game that has developed during the advent of the computer age is where the user physically visits certain locations and updates the computer system as to the identified clues. However, a drawback of such systems is that the user must physically be able to visit each of the sites where each of the clues is located. What is required is a method and system that allows a user to locate clues without being physically present, by utilizing augmented reality.

### SUMMARY OF THE INVENTION

The present invention applies augmented reality principles to allow the user of a game to locate clues that are remote from him.

The system and method will provide improved game play functionality.

### BRIEF DESCRIPTION OF THE DRAWINGS

Preferred embodiments of the invention are described herein below with reference to the drawings wherein:

FIG. 1 illustrates the process flow of one embodiment of the invention;

FIG. 2 illustrates the process flow of a second embodiment of the invention; and

FIG. 3 illustrates an example of a dynamically created identification tag.

### DETAILED DESCRIPTION OF THE INVENTION

The disclosure herein provides a computer implemented method and system that enables the availability of augmented content to be democratized, particularly in embodiments when the method is part of a “treasure hunt” or “scavenger hunt.” In known hunts a user travels to a specific location to point their device camera at a particular place or object to activate the augmented reality content. In the present disclosure, a system and method is provided where the resources that a user needs to enable display of augmented reality content are ubiquitous—a user device, and external resources containing images, sounds, or multimedia content to be matched.

These resources, as explained further herein, include books that are owned by many or are available at a local libraries, various objects, and a “source” display.

The user device can be a computer of any suitable form factor, with integrated or external audio and/or video capture hardware, such as a smartphone, tablet computer, pocket computer, smart watch, laptop or netbook computer. It can also be a wearable computer such as a standalone virtual reality glasses (with full hardware functionality for display, camera, audio, processor, memory), or virtual reality glasses or head-mounted accessory to be used in conjunction with another device such as a smartphone or a tablet. It can also be any type of computer using external hardware for video and/or audio capture.

The source display can be any display separate from the user device display, such as one or more of a television, computer monitor, tablet, or smartphone. In certain embodiments the source display is the display of another user's device that can carry out the method described herein.

Computer-implemented methods for providing an augmented content display are described. The methods include underlying steps to install a program application on the user device that carries out the herein described method, among other features and functionalities. The application contains multimedia functions related to:
external resources, including identification of those that have been captured (and optionally triggered display of augmented reality content) in accordance with system and method herein, and others that are not captured but inputted by other means by the participant, such as one or more questions related to a book or video;
an interactive environment, such as an interactive map or panorama through which the participant navigates to find clues, solve puzzles, and to interact with matched external content, as enhanced by the system and method herein;
a participant achievement or leaderboard section, in which a participant can view captured external resources and other achievements within the interactive environment.

When a participant captures an external resource, at least one or both of the following occurs:
augmented reality content is displayed to the user, as entertainment, to provide informative or infotainment content, to reveal a clue to the participant related to something with the interactive map or panorama, and/or to reveal a clue to the participant related to another external resource to capture;
the interactive environment is customized so that when certain external resources which have been captured appear in the interactive environment.

Included in the process of program installation and configuration is establishment of a database, or a networked connection to a database. The network can be local network, such as a wireless network within a user's home, to establish connectivity to one or more locally accessible storage devices such, for instance maintained on one or more local computers or servers separate than the user device. The network can also be a remote network, such as the Internet, to establish connectivity to one or more remotely accessible storage devices, for instance maintained one or more computers or servers separate than the user device. Any necessary local and/or remote network credentials should also be established during program installation, or before a user attempts to display augmented content as described herein.

The database contains predefined images associated with external resources, and an associated action. The external resources are the content that contains the images captured by a user. In certain embodiments, the associated action is the display of augmented content, for instance, in a “layer” that overlays imagery in the viewfinder of the external resource. In other embodiments, separate content is presented to the user. In further embodiments, the occurrence of the match is used to modify other aspects of the application, for instance to customize the interactive environment so as to display certain images or provide certain content within the interactive environment corresponding to the matched external resource.

In certain embodiments, external resources can be static, dynamic, or both static and dynamic, which can be stored in the same or different databases. In certain embodiments, all static and dynamic external resources can be stored in the same database, and individual external resources are designated as static or dynamic. In additional embodiments, all static external resources are stored in a first database, and all dynamic external resources are stored in a second database. In still further embodiments, all static external resources and a subset of dynamic external resources are stored in a first database (appropriately designated within that first database as static or dynamic), and additional dynamic external resources are stored in a second database. When all or certain dynamic resources are stored in a separate database, different entities can contribute to those databases. For instance, an entity can have the ability to separately create and control access to a separate database, or only designated dynamic external resources in that database. Additional permissions (such as parental permissions) can be required to access that separate database.

Static external resources include those that in some form of a static or “permanent” publication, while dynamic external resources typically change over time. Examples of static external resources are books, magazines, movies, television episodes, trading cards, or physical objects such as toys, amulets, tattoos. Examples of dynamic external resources include websites, social media, participant-created content, online maps or panoramic virtual view applications such as Google Street View. For example, these dynamic external resources can be managed by the distributor of the program application described herein, and/or all or part of its content, or a third party entity. The dynamic external resources can be in the form of, for instance, websites, leaflets that can be printed for time-based events, information screens in public places, or social media resources on which the distributor can post. In other examples, global positioning system (GPS) implementation can be enabled for specific location-based information. In additional embodiments, dynamic content can be location-specific, for instance, so that appropriate resources and associated augmented content are available to users at particular locations such as a country that has the episodes airing on television. In further embodiments, dynamic content can be participant-created content such as a drawing or photograph that can be augmented when viewed by another participant, and/or which can appear in the interactive environment. Items with Bluetooth capability, such as an amulet or wearable, could function as either a static external resource or a dynamic external resource.

Certain forms of external resources are transient. They are embedded within a moving display. For instance, within a particular video (which can include but is not limited to a movie, television show, internet video) a predefined image or series of images within that video is the trigger. This could be accomplished by predefined scenery, such as the background imagery within the episode or story, or when a certain object or location appears in the display. When predetermined character mode is captured by the user on via their device camera, the augmented content is displayed. However, when that predefined portion of the scheme is not present, the image is no longer available to trigger the display of augmented content.

Note that in embodiments herein in which the external resources are transient, content can be used as dynamic or static external resources. In further embodiments, transient external resources can be used in an application in which the different types of external resources are not used.

Other types of transient images or series of images could include predetermined character modes, such as a pose, facial expression, body language, dancing, body motion, interactions with other characters or objects, or verbal expressions. When a predetermined character mode is captured by the user on via their device camera, the augmented content is displayed. However, when the character mode changes the image is no longer available to trigger the display of augmented content.

For example, within a television episode, hidden and/or visible clues are embedded. A visible clue is an image or series of images sought and scanned by the participant matching a predetermined image or predetermined series of images. What image or series of images to scan can depend on the mode of the application. For instance, when a participant is exploring the interactive environment while watching the episode, a clue can appear within the interactive environment to seek on the television program, such as a scroll with a map. When the character in the television episode encounters the scroll with a map, the participant knows to capture the image in the viewfinder of the user device. A hidden clue can be one that part of the background scenery, or a pattern of moving images, that when matched with predetermined images, activates external content for display or presentation to the user device, and/or enables additional content in the interactive environment.

In additional embodiments, the content to be captured can be audio. For instance, when the audio track of a television episode is recognized by the user device that is matched with a predetermined audio track, external content can be activated for display or presentation to the user device, and/or additional content in the interactive environment is enabled.

In further embodiments, there could be elements in the television episode that the participant is cued to identify, for instance by the character or narrator of the episode. For example, a participant can be cued to count a certain number of a sheep in a scene, and as a result of an answer by the participant, external content can be activated for display or presentation to the user device, and/or additional content in the interactive environment is enabled.

In one embodiment, dynamic crossmedia sequential clueing (DCSC) is employed, for example scanning an image from a book, then tapping on a touch-sensitive screen to grab an element, then listening to a melody played in a game episode, then solving a puzzle within a particular length of time. These are sequential sub-tasks that must be done in order, involving different types of clues and different user interface methods, before the app recognizes the overall task as being completed.

In a further embodiment, dynamic crossmedia parallel clueing (DCPC) is employed for delivering to users or receiving a response from a user. With this embodiment, clues are presented and/or handled simultaneously. Cross-media can involve a single user, or can also work in multi-player mode. For example, one user can scan an augmented page from a book, while a second user is simultaneously listening to a melody in an episode. Or for example, two users will simultaneously scan a particular page of a book, at which time the network-player mode will recognize the action and produce the next clue.

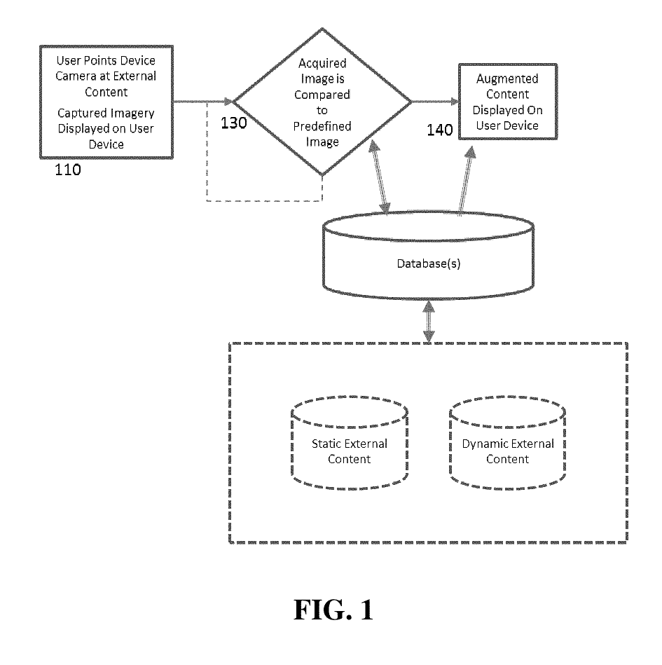

An example of computer-implemented method for providing an augmented content display is shown in the flowchart of FIG. 1. FIG. 1 presumes that the user has taken the steps necessary to open the program application, enable the functionality of the device hardware (internal or external) including the camera and display (and optionally audio capture and presentation), and enable the functionality of the associated operation within the program application for presentation of augmented content.

Enablement of the necessary functionality can be automatic upon opening of the program application, or require one or more user inputs. For instance, upon opening of the program application, the viewfinder of the user device is activated, prompting the participant to capture an external resource. Alternatively, a mode is selected by the participant to activate the viewfinder. In another example, when the participant is engaged in an interactive environment, a window within the display can contain a viewfinder, which can be toggled on and off by the participant. In certain embodiments, there is no viewfinder, but rather the image capture occurs in the background.

At 110 of the process flow, the user positions the user device so that an image of external content is in the camera field of view. A computer generated representation of the image is simultaneously displayed on the user device.

At 130, the computer generated representation of the external content is compared to predefined images in the one or more associated external content databases, including in certain embodiments one or more static and/or dynamic databases as described above. This process continued in a loop until a match is made. The loop can be continuous, or at predefined intervals. Alternatively, the user can select a time to implement 130.

At 140, when a match is identified at 130, external content can be activated for display or presentation to the user device, and/or additional content in the interactive environment is enabled. For instance, the external content can be augmented content associate with the external content that is displayed on the user device display (such as “bringing to life” a still image in the viewfinder of the user display device with additional content). This augmented content is a virtual image that overlays the underlying image on the user's display. The augmented content can be a photograph, drawing, animation, video, other visual forms of media that overlay on the user's display, and can be accompanied by audio. The content displayed to the user is based on information associated with the image matched in the database.

In additional embodiments, in addition to or separate from presentation of external content to the user overlaying the image in the viewfinder, additional content in the interactive environment is enabled. In this manner, when a participant navigates to a certain location in the interactive environment, content appears associated with the matched (130) resource.

Any suitable algorithms/modules that are known in the art are applied to compare the computer generated representation of the external content and display the augmented content.

Specific details of such algorithms/modules for comparing external content to predefined images (130) and displaying the augmented content (140) include information available about known commercially available platforms, such as those available from Unity Technologies (http://unity3d.com/) and PTC Inc. under the name Vuforia (http://www.vuforia.com).

In an example, the application operates across multiple forms of media including a book, television episode and a website [(a), (b) and (c) as used in conjunction with an iteration of the flow chart shown above). Information from the distributor of the program application described herein, and/or all or part of its content, can be conveyed to the user to find a first image that matches a predefined image in a database. For instance, a user can be directed to an image in a book (a). When the user views the image (110)(a) in the book (a) and a match is established (130)(a), augmented content (a) is displayed to the user (140)(a). Continuing with the example, the augmented content (a) contains a clue regarding a second image that the use should seek, such as within a television episode (b) related to a character in the book containing the first image. When the user views a scene (110)(b) in the episode (b) containing the second image, and a match is established (130)(b), augmented content (b) is displayed to the user (140)(b). The augmented content (b) contains a clue regarding a third image that the use should seek, such as within a website (c). The user navigates to the webpage so that it is displayed on another separate device, such as on a computer monitor, a television, a tablet device, or a smartphone. When the user views the image (110)(c) in the website (c) containing the third image, and a match is established (130)(c), augmented content (c) is displayed to the user (140)(c). Augmented content (c) contains a clue regarding a fourth image that the use should seek, and so on.

In the above example, the images matched at 130(a), 130(b) and 130(c) are compared to a database containing predefined images and associated augmented content to display. In certain embodiments, certain of the images are considered static external content and others are considered dynamic external content. For example, the images matched at 130(a), 130(b) associated with the book and television episode are static external content and the image matched at 130(c) is dynamic external content, as it is expected to change over time. Further, the dynamic external content can be managed by a third party entity (other than the distributor of the program application described herein, and/or the static external content), such as the network/platform that airs the episode (b), or an advertiser of such network/platform, so that it leads the user to a website (c) that is managed by such third party entity.

In addition, the program application can record the instance of capture by the user. In an interactive environment, other actions can occur, such as collection of an award or tag, when a match (130) is established. When a certain number of designated matches (130) are made, other actions can be triggered.

In other embodiments, a combination of external resources can be captured to enable display of different content, contemporaneously with the capture (140) and/or within the interactive environment. For example, a group of “stickers” or other tangible objects containing images are captured (110); if the database comparison establishes a match (130) the content is displayed. The sequence in which these objects are placed also can modify the content displayed contemporaneously with the capture (140) and/or within the interactive environment. As an example, if a group of stickers corresponding to buildings are arranged and viewed, augmented content will appear to the user, for example, images on the user device display of a building hovering over each sticker. The application also collects “tags” corresponding to each of the individual stickers. When the user is in the interactive environment, those virtual buildings corresponding to the tags are displayed and can form a virtual city and part of the panorama for the user to explore.

In other embodiments, when a certain external resource is captured, from a transient source or other source, or for instance when a group or sequence of objects is captured, the triggered activity could be advancing the participant to a specific location in the interactive environment or time in the storyline.

In certain embodiments, the augmented content associated with a particular image in the database can change. For instance, content associated with a holiday or special event can be implemented during those events. In further embodiments, the augmented content associated with a particular image in the database can change depending on how many times a particular user has viewed that content, or what other content the user has viewed. In additional embodiments the same predefined image can be associated with several augmented content overlays, for example, based on a preselected user theme, user age-level, or other selections that can be made by the user or administrator (e.g., parent).

In certain embodiments, the augmented content and cross-media applications enhances a storyline of a book/televisions show. In an implementation, a user may be instructed to start with identifying an image in a book, using a camera integrated within their device to view the predetermined static media to thereby reveal additional information by way of images, video or other info that leads the user to the next predetermined trigger. For instance, the second predetermined trigger can be a particular activity occurring within the television show of the character. When the user positions their camera so that they are viewing the television show through their device, augmented reality television appears during the transient time period of that second predetermined trigger. That is, the predetermined trigger in this instance can be a series of images timed accordingly to the timing of the television show. Alternatively, it can be a single image during the transient time period of that show.

In a further embodiment, speech recognition is incorporated allowing a user to speak commands to select augmented content, such as triggering elements within a game, focusing on or zooming in to a particular element, controlling an element or character's movements or actions within a game, or saving the status of a game for resumed play later.

In a further embodiment, camera gesture controls are incorporated, allowing a user to interact with the game with gestures he makes using his hands or body.

In a further embodiment, face expression recognition is incorporated allowing a user to interact with the game, such as mimicking emotions, showing an emotion called for by game play, or motioning with the chin or lips.

In a further embodiment, color recognition and color tracker technology is integrated, such that one or more objects with one or more colors can be tracked by a camera, allowing integration with the game, such as disclosed at https://www.youtube.com/watch?v=sKGrJx4CSeY.

In further embodiments, multiple participants can engage each other in a shared interactive environment. The participants can share or trade collected resources.

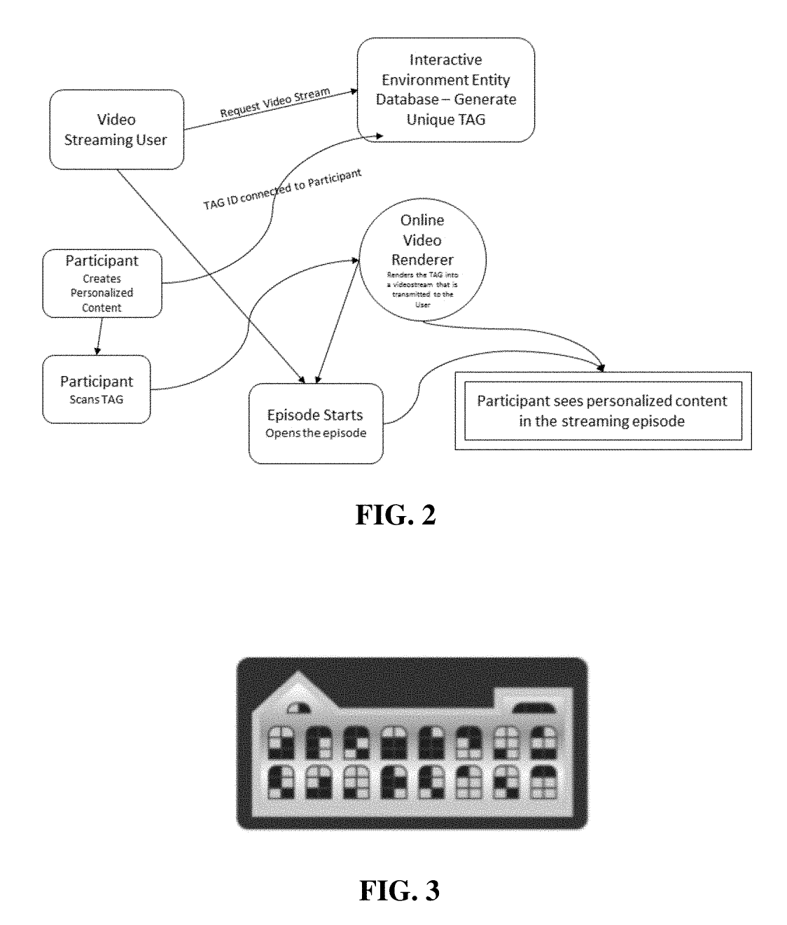

In a further embodiment, the application can enhance the experience of a video streaming episode, as shown also with respect to FIG. 2. The user initiates a streaming video episode on a device other than the user device. A unique identification tag is created. This unique identification tag is embedded in the streaming video episode. When the user scans the unique identification tag, extra content is rendered.

In certain embodiments, the episode is streamed from a video streaming module (e.g., using a third party entity such as www.Netflix.com) separate than the entity that establishes the databases used in the system and method herein (referred to as the “interactive environment entity”), and a further rendering module that embeds the unique identification tag and extra content (e.g., using a third party entity such www.rednun.nl). The video streaming module and the rendering module can also be established by the same entity, which can also be the interactive environment entity. In an example, the server of the video streaming service requests a unique identification tag from the database associated with the interactive environment entity, and this tag is dynamically created. For example, this tag can be one of several image bases, with minor variants, as shown in FIG. 3.

The window locations alone can enable countless possibilities for unique tags. The rendering entity embeds this tag in the videostream. When the user scans the tag with the user device, the unique tag is decoded and matched with the user registered stream. At this stage the rendering module incorporated additional content custom to the user into the video stream. In addition it is possible for one or more of the involved entities to ascertain whether a user has watched or is in the process or watching an episode.

In addition, the resources collected by the application can be associated with the content rendered in the video stream. For example, a participant-created drawing or photo is created and scanned in the application. This item becomes custom content to be rendered in the video stream. For instance, the character in the episode can open mail and show a drawing corresponding to the drawing uploaded by the user. Cumulatively, the character can receive more of such drawings, and past content is displayed, for instance, on a desk or wall in the scene behind the character.

According to the system and method herein, it is possible to share assets between multiple modes of media, such as television, streaming video, and user engaged interactive environments. The interactive environment can contain scenery and audio-video content from the television and/or streaming video episodes, and vice-versa.

In alternate embodiments, the present invention can be implemented as a computer program product for use with a computerized computing system. Those skilled in the art will readily appreciate that programs defining the functions of the present invention can be written in any appropriate programming language and delivered to a computer in any form, including but not limited to: (a) information permanently stored on non-writeable storage media (e.g., read-only memory devices such as ROMs or CD-ROM disks); (b) information alterably stored on writeable storage media (e.g., floppy disks and hard drives); and/or (c) information conveyed to a computer through communication media, such as a local area network, a telephone network, or a public network such as the Internet. When carrying computer readable instructions that implement the present invention methods, such computer readable media represent alternate embodiments of the present invention.

As generally illustrated herein, the system embodiments can incorporate a variety of computer readable media that comprise a computer usable medium having computer readable code means embodied therein. One skilled in the art will recognize that the software associated with the various processes described can be embodied in a wide variety of computer accessible media from which the software is loaded and activated. Pursuant to In re Beauregard, 35 U.S.P.Q.2d 1383 (U.S. Pat. No. 5,710,578), the present invention contemplates and includes this type of computer readable media within the scope of the invention. In certain embodiments, pursuant to In re Nuuten, 500 F.3d 1346 (Fed. Cir. 2007) (U.S. patent application Ser. No. 09/211,928), the scope of the present claims is limited to computer readable media, wherein the media is both tangible and non-transitory.

The system and method of the present invention have been described above and with reference to the attached figures; however, modifications will be apparent to those of ordinary skill in the art and the scope of protection for the invention is to be defined by the claims that follow.

1. A computer-implemented method for providing an augmented content display comprising:
on a user device including an image capture, a display and a processor,
capturing an image from external content with the image capture of the user device and displaying the image on the display;
generating computer-generated imagery data based on the image;
comparing the imagery data to one or more predefined images stored in a database [contained in the memory of the device or in a networked server], each predefined image associated with augmented content, wherein each predefined image of external content is designated as static or dynamic;
overlaying the augmented content on the computer-generated imagery when at least one of the transient images matches one or more of the predefined images.

2. A computer-implemented method for providing an augmented content comprising:
on a user device including a camera, display and processor,
capturing video from a separate video display with the camera of the user device and displaying the video on the display of the user device;
generating computer-generated imagery data based on the video;
displaying on the display of the user device the computer-generated imagery representing the separate video display;
parsing the video into a plurality of transient images;
comparing the transient images to one or more predefined images [stored in a database contained in the memory of the device or in a networked server], each predefined image associated with augmented content;
overlaying the augmented content on the computer-generated imagery when at least one of the transient images matches one or more of the predefined images.

3. An augmented reality device, comprising:
a camera for capturing a video from a separate video display for display on a display of the device;
a processor coupled to the video camera and the display, the processor configured for:
modeling a computer-generated imagery representing one or more objects depicted in the video of the separate video display, wherein modeling the computer-generated imagery includes overlaying an augmented content layer on the computer-generated imagery, combining the augmented content layer and the video for presentation on the display, and
displaying the augmented content layer and the computer-generated imagery representing one or more objects with the video on the display.
